(19) United States
(12) Patent Application Publication
(10) Pub. No.: US 2018/0146810 A1
(43) Pub. Date: May 31, 2018

(54) COOKING MACHINE

(71) Applicant: CHEN-YUAN LU, Taichung (TW)

(72) Inventor: CHEN-YUAN LU, Taichung (TW)

(21) Appl. No.: 15/361,393

(22) Filed: Nov. 26, 2016

(51) Int. Cl. A47J 27/00; A47J 27/04; A47J 36/06

(52) U.S. Cl. CPC A47J 27/002; A47J 27/04; A47J 2027/043; A47J 36/06; A47J 27/004

(57) ABSTRACT

A cooking machine includes a body having a room in which a container holder is movably located. The container holder can be moved into or removed out from the room. A heating unit has a first heater which is located in the room and movable to be inserted into a container on the container holder along vertical direction so as to cook food in the container.

### BACKGROUND OF THE INVENTION

### 1. Fields of the Invention

The present invention relates to a cooking machine, and more particularly, to a cooking machine which cooks food by way of steaming and stewing.

### 2. Descriptions of Related Art

The conventional cooking machine usually is used in convenience stores generally includes a multiple separated rooms and broth or water is received therein, food is cooked or stewed in the broth or water for a long period of time to provide hot food to the customers. Nevertheless, not every kind of food is suitable to be cooked or strewed in water or broth. Therefore, a multiple-function cooking machine is needed to meet different needs from the users.

The present invention intends to provide a cooking machine that provides multiple different cooking methods to treat food.

### SUMMARY OF THE INVENTION

The present invention relates to a cooking machine and comprises a body having a room defined therein, and a container holder is movably located in the room. The container holder can be removed out from the room. A heating unit has a first heater which is located in the room and movable to be inserted into a container on the container holder along a vertical direction to cook food in the container.

Preferably, the container holder has a support rail, a tray and a first driving unit. The support rail is located on an inner bottom of the room. The tray is movably put on the support rail. The first driving unit is connected to the tray which is driven by the first driving unit to move along the support rail to move the tray out from the room or to retreat the tray into the room.

Preferably, the container holder includes a first quick-release which is located in the room to position the support rail on the inner bottom of the room.

Preferably, the first quick-release has a fixed recess, an engaging recess and a pivot portion. The fixed recess and the pivot portion are located on two ends of the first quick-release. The engaging recess is located between the fixed recess and the pivot portion.

Preferably, the first driving unit comprises a power source, a pivot connected to the power source, and a first arm located in the room. The first end of the first arm is connected to the pivot, and the second end of the first arm has a rod. The tray has a guide rail on the underside thereof. The rod is inserted into the guide rail.

Preferably, the tray has a positioning boss on each of four corners thereof.

Preferably, the container is a steamer which is put on the tray and positioned by the positioning bosses.

Preferably, the steamer comprises a top part, a bottom part and a rack. The rack is located between the top and bottom parts. The top part and the rack each have an aperture. The two respective apertures share a common axis. The first heater is inserted into the two respective apertures and reaches beneath the rack.

Preferably, the tray has a positioning device at the center thereof.

Preferably, the tray has a pair of frames which are arranged to be an X-shaped combination and fixed to the positioning device.

Preferably, the container is a bowl or a plate, and the container is put on the frames.

Preferably, the container includes a bowl cover which is mounted to the bowl. The bowl cover has an aperture. The first heater is inserted into the aperture and reaches the interior of the bowl.

Preferably, the cooking machine further comprises a quick-release board and a second quick-release. The quick-release board is connected to sidewalls of the room by the second quick-release.

Preferably, the second quick-release has a fixed recess, an engaging recess and a pivot portion. The fixed recess and the pivot portion are located on two ends of the second quick-release. The engaging recess is located between the fixed recess and the pivot portion.

Preferably, the quick-release board includes a board and a first slide. The board includes a slot in which the first slide is located. The first heater is fixed to the first slide so as to be moved with the first slide along the slot.

Preferably, the cooking machine further comprises a food container which is connected to the quick-release board. The quick-release board includes a board and a second slide. The board has a container rail. The second slide is movable along the container rail.

Preferably, the container rail has at least one curved portion.

Preferably, the cooking machine further comprises a third quick-release. The food container is fixed to the second slide by the third quick-release.

Preferably, the third quick-release has a fixed recess, an engaging recess and a pivot portion. The fixed recess and the pivot portion are located on two ends of the third quick-release. The engaging recess is located between the fixed recess and the pivot portion.

Preferably, the first heater moves along the vertical direction and is pivoted relative to the vertical direction so as not to interfere the food container moving toward the container holder on the container rail.

Preferably, the first heater includes a first tube, a second tube and a third tube, the second tube is mounted to outside of the first tube, and the third tube is mounted to the second tube. The cooking machine further comprises multiple pipes. Multiple supply sources are respectively connected to the first, second and third tubes via the multiple pipes. The cooking machine includes a board and a fourth quick-release. The multiple pipes are connected to the board which is fixed to the sidewalls of the room of the body via the fourth quick-release. The fourth quick-release includes a fixed recess, an engaging recess and a pivot portion. The fixed recess and the pivot portion are located on two ends of the fourth quick-release. The engaging recess is located between the fixed recess and the pivot portion.

Preferably, the cooking machine includes a door which is pivotably connected to one side of the body. A door lock unit is located at the other side of the body and includes a switch, a link and a hook. The switch has one end exposed from the room. The hook protrudes beyond the sidewall so as to hook the door. The link is connected between the switch and the hook. When the switch is operated, the hook is driven by the link to be disengaged from the door. The door has an entrance/exit, and the container on the container holder is able to pass through the entrance/exit.

Preferably, the door has a feeding hole through which food is fed into the room.

Preferably, the cooking machine comprises multiple nozzles located in the room to clean the room.

Preferably, the inner bottom is tilt relative to the sidewalls. A leakage hole is defined through the inner bottom.

The cooking machine is easily to maintain or replace the parts via the quick-releases. The power source is located outside of the room so as not to be affected by liquid and heat, so that the cooking machine has longer life of use.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the cooking machine of the present invention;

FIG. 2 is a perspective view to show the cooking machine of the present invention;

FIG. 3 shows the container holder of the cooking machine of the present invention;

FIG. 4 shows another perspective view of the container holder of the cooking machine of the present invention;

FIG. 5A shows that a steamer on the container holder is moved into the room of the cooking machine;

FIG. 5B is a cross sectional view of FIG. 5A;

FIG. 6A shows that the first heater is inserted into the steamer;

FIG. 6B is a cross sectional view of FIG. 6A;

FIG. 6C shows that the first heater reaches beneath the frames;

FIG. 7 shows the open front of the cooking machine;

FIG. 8 shows the structure of the inner bottom of the room of the cooking machine;

FIG. 9 shows that the container which is a bowl is put on the container holder;

FIGS. 10A through 10D show that the food container is fixed to the second slide by the third quick-release;

FIG. 11 shows that the food container is received in the liquid tank, and the food in the food container is heated;

FIG. 12 shows that the food in the food container is poured into a bowl;

FIG. 13 shows that the door has a feeding hole;

FIG. 14 shows that the lower end of the first heater is inserted into the bowl;

FIG. 15 shows the first heater;

FIG. 16 shows the supply sources are connected to the tubes of the first heater via the pipes, and

FIGS. 17A and 17B show the door lock unit.

### DETAILED DESCRIPTION OF THE PREFERRED EMBODIMENT

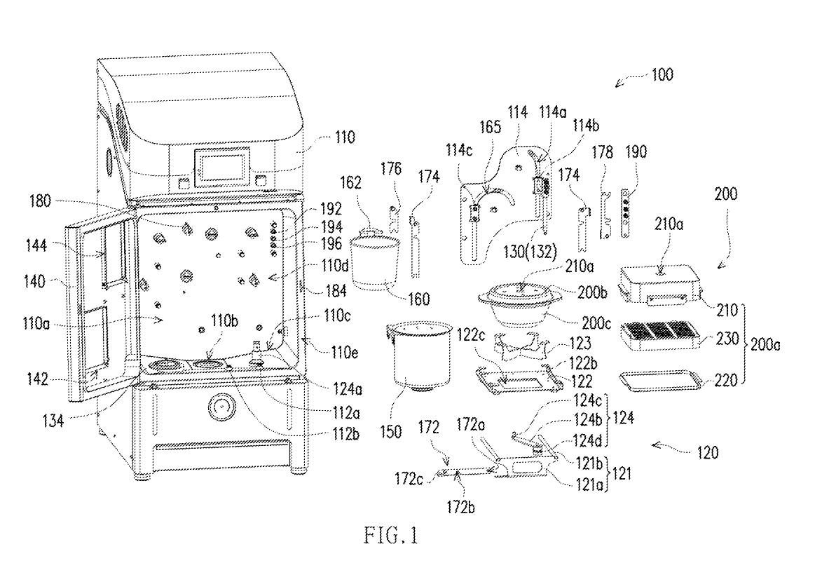

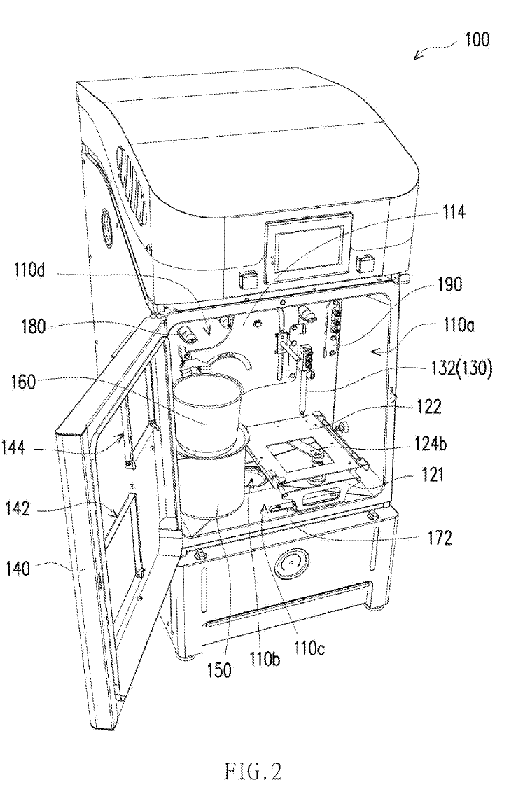

Referring to FIGS. 1 and 2, the cooking machine 100 of the present invention comprises a body 110, a container holder 120 and a heating unit 130. The body 110 has a room 110a defined therein, and the container holder 120 is movably located in the room 110a and capable of removing out from the room 110a. The heating unit 130 includes a first heater 132 which is located in the room 110a and movable to be inserted into a container 200 on the container holder 120 along a vertical direction so as to cook food in the container 200. The container 200 can be a steamer 200a or a bowl 200b.

As shown in FIGS. 2 to 4, the container holder 120 has a support rail 121, a tray 122 and a first driving unit 124. The support rail 121 is located on the inner bottom 110c of the room 110a. The tray 122 is movably put on the support rail 121. The first driving unit 124 is connected to the tray 122 which is driven by the first driving unit 124 to move along the support rail 121 to move the tray 122 out from the room 110a or to retreat the tray 122 into the room 110a.

The inner bottom 110c of the room 110a has multiple protrusions and the support rail 121 is engaged with the protrusions. The container holder 120 includes a first quick-release 172 which is located in the room 110a so as to position the support rail 121 to the protrusions on the inner bottom 110c of the room 110a. Specifically, the protrusions may be two protrusions 112a, 112b, and the support rail 121 is composed of a curved plate 121a and a pivot 121b. The plate 121a has holes 121c through which the protrusions 112a, 112b extend. The first quick-release 172 has a fixed recess 172a, an engaging recess 172b and a pivot portion 172c. The fixed recess 172a and the pivot portion 172c are located on two ends of the first quick-release 172. The engaging recess 172b is located between the fixed recess 172a and the pivot portion 172c. The fixed recess 172a and the engaging recess 172b are formed on the side of the first quick-release 172 and recessed toward the inside of the first quick-release 172. When the plate 121a is mounted to the protrusions 112a, 112b by the holes 121c, the fixed recess 172a is secured to the protrusion 112a, and then the pivot portion 172c of the first quick-release 172 is pivoted about the protrusion 112a to pivot the first quick-release 172 to engage the engaging recess 172b with the protrusion 112b, so that the support rail 121 is secured on the inner bottom of the room 110a.

The first driving unit 124 comprises a power source 124a, a pivot 124d connected to the power source 124a, and a first arm 124b located in the room 110a. The first end of the first arm 124b is connected to the pivot 124d and the second end of the first arm 124b has a rod 124c. The tray 122 has slide on the underside thereof, the slide has a guide rail 122a. The rod 124c is inserted into the guide rail 122a. When the power source 124s is activated, the power source 124a drives the pivot 124d to rotate the first arm 124b about the pivot 124d. By the cooperation of the rod 124c and the guide rail 122a, the tray 122 is able to be moved out from the room 110a or retreated from outside of the room 110a.

The tray 122 has a positioning boss 122b on each of four corners thereof. The container 200 is a steamer 200a which is put on the tray 122 and secured by the positioning bosses 122b. The steamer 200a comprises a top part 210, a bottom part 220 and a rack 230. The rack 230 is located between the top and bottom parts 210, 220. The top part 210 and the rack 230 each have an aperture 210a, and the two respective apertures 210a share a common axis. The first heater 132 is inserted into the two respective apertures 210a and reaches beneath the rack 230 so as to heat the food in the steamer 200a.

The cooking machine 100 includes a door 140 which is pivotably connected to one side of the body 110 so that the door 140 is opened or closed relative to the body 110. When the door 140 is opened, the room 110a is an opened, and when the door 140 is closed, the room 110a is an enclosed room.

The door 140 has an entrance/exit 142, and the container 200 on the container holder 120 is able to pass through the entrance/exit 142 which may have a door-like member. When the door-like member is applied a force from the container holder 120, the door-like member is opened relative to the door 140 to allow the tray 122 to move to outside of the room 110a. When the container holder 120 does not apply a force to the door-like member, the door-like member is closed.

The cooking machine 100 further comprises a quick-release board 114 and a second quick-release 174, wherein the quick-release board 114 is connected to sidewall 110d of the room 110a by the second quick-release 174. The sidewall 110d has multiple protrusions (not numbered), and the quick-release board 114 has multiple holes (not numbered) with which the protrusions on the sidewall 110d are engaged. The second quick-release 174 is connected to the protrusions on the sidewall 110d to be secured on the sidewall 110d. In order to secure the quick-release board 114, two second quick-releases 174 are used to secure two sides of the quick-release board 114.

The quick-release board 114 includes a board (not numbered) and a first slide 114b. The board includes a slot 114a in which the first slide 114b is located. The slot 114a includes a vertical portion and a curved portion. The first slide 114b is moved along the slot 114a. The first heater 132 is fixed to the first slide 114b so as to be moved with the first slide 114b along the slot 114a.

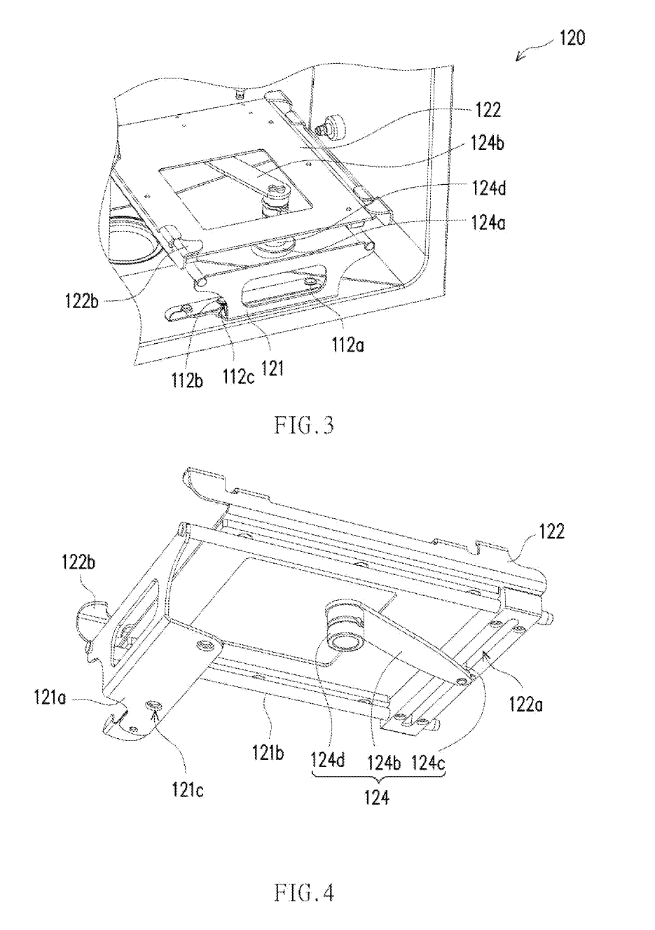

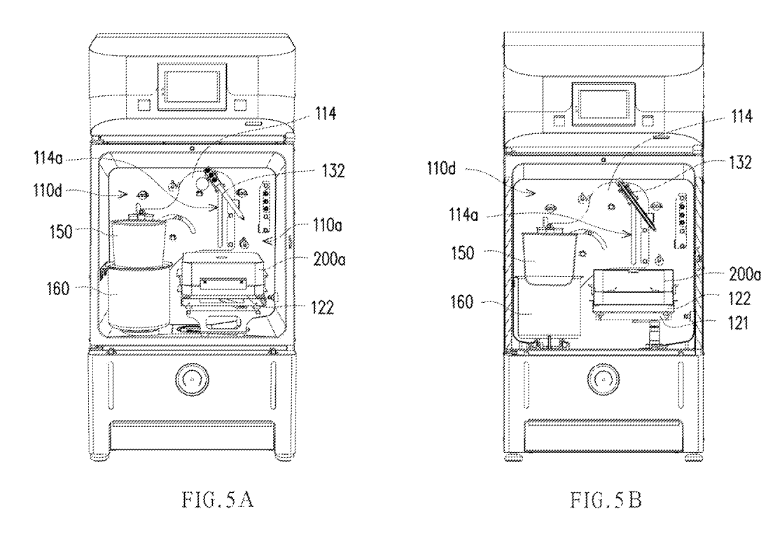

As shown in FIGS. 3 and 4, when steaming food by using the steamer, the user pushes the button on the cooking machine 100 to activate the power source 124a of the first driving unit 124 so that the power is transferred to the first arm 124b via the pivot 124d. The end with the rod 124c of the first arm 124b is pivoted about the pivot 124d. The rod 124c is inserted into the guide rail 122a, so that the tray 122 is moved out from the room 110a when the rod 124c is moved in the guide rail 122a. The tray 122 opens the door-like member of the entrance/exit 142, and the tray 122 is moved to the outside of the room 110a. The user puts the steamer 200a on the tray 122, and the power source 124a of the first driving unit 124 is activated in reverse direction to retreat the tray 122 into the room 110a. The door-like member is closed when the tray 122 is retreated in the room 110a. In this embodiment, the power source 124a is a motor.

By the cooperation of the power source 124a, the pivot 124d, the first arm 124b, the rod 124d and the guide rail 122a, the tray 122 can be moved smoothly, and the parts needed for moving the tray 122 is limited.

As shown in FIGS. 5A and 5B, when the tray 122 is retreated into the room 110a, the first heater 132 is moved with the first slide 114b (FIG. 1) and located at the curved portion of the slot 114a.

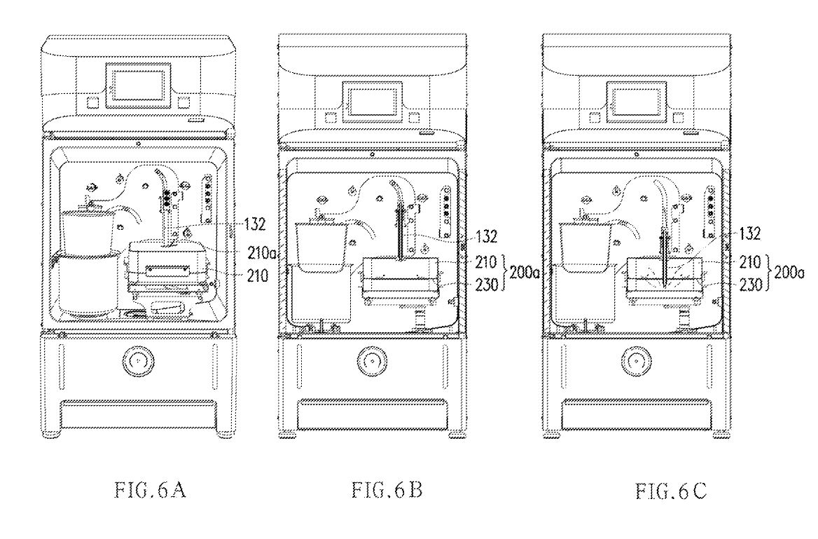

As shown in FIGS. 6A, 6B and 6C, the first heater 132 along with the first slide 114b are inserted into the two respective apertures 210a along the vertical direction and inserted into the apertures 210a of the top part 210 and the rack 230 to reach beneath of the rack 230. The first heater 132 releases steam to heat the food in the steamer 200a.

After the food is heated, the first driving unit 124 is activated again to push the tray 122 out from the room 110a, the user removes the steamer 200a and enjoys the food in the steamer 200a.

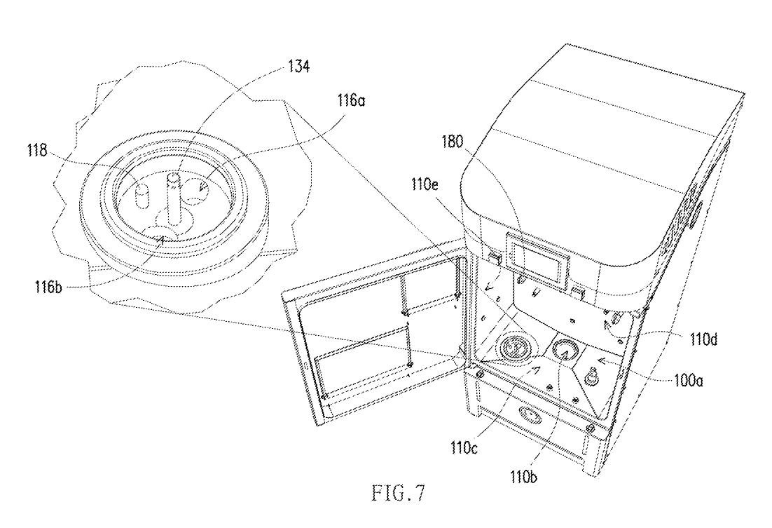

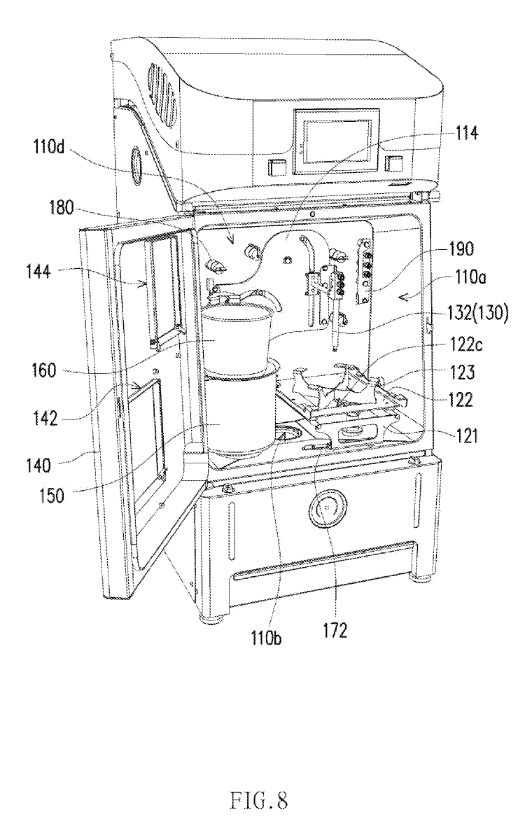

As shown in FIG. 7, the inner bottom 110c is tilt relative to the sidewalls 110d, 110e. A leakage hole 110b is defined through the inner bottom 110c. The tilt inner bottom 110c helps the condensed liquid in the room 110a to leak from the room 110a.

The cooking machine 100 comprises multiple nozzles 180 located in the room 110a to clean the room 110a. The nozzles 180 are in communication with the cleaning agent stored in the underside of the room 110a, and the cleaning agent is mixed with water to clean the room 110a.

The tray 122 has a pair of frames 123 which are arranged to be an X-shaped combination and fixed to the positioning device 122c. The tray 122 has a positioning device 122c at the center thereof. The bowl 200c is stably put on the racks 123 and positioned by the positioning device 122c. The positioning device 122c can be a recess or an opening which can secure the frames 123 to the positioning device 122c. The frames 123 lifts the bowl 200c and the distal ends of the frames 123 hold the bowl 200c.

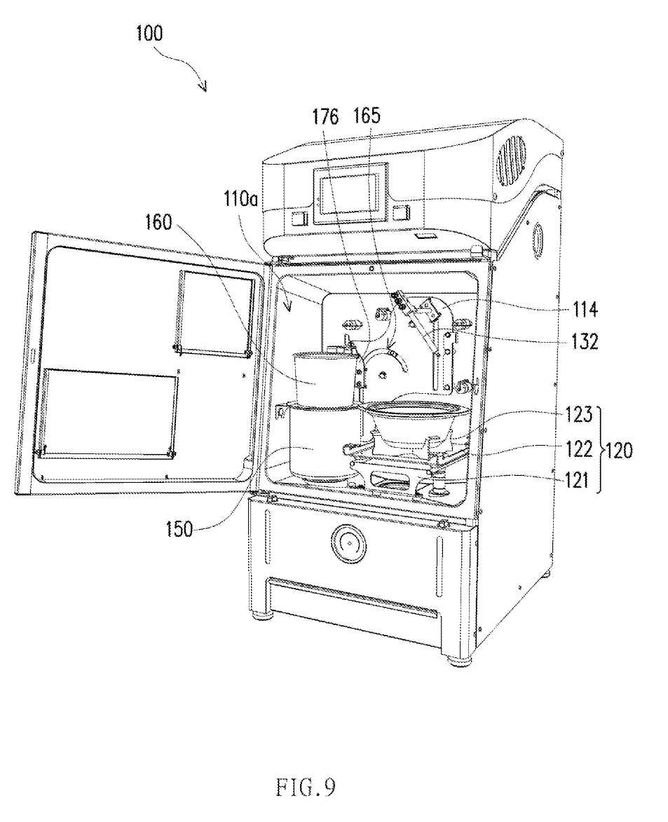

As shown in FIG. 9, the cooking machine 100 provides noodles-cooking function. A liquid tank 150 is located beside the container holder 120, and receives water or oil therein, depends on the way of cooking such as boiling or frying.

The heating unit 130 includes a second heater 134 which is located beneath the liquid tank 150 and extends into the interior of the liquid tank 150 so as to heat the liquid in the liquid tank 150. The second heater 134 is identical with the first heater 132 to release steam.

The cooking machine 100 further comprises a food container 160 which is connected to the quick-release board 114. The quick-release board 114 includes a board and a second slide 114c. The board has a container rail 165, and the second slide 114c is movable along the container rail 165. The food container 160 is connected to the second slide 114c and moved with the second slide 114c.

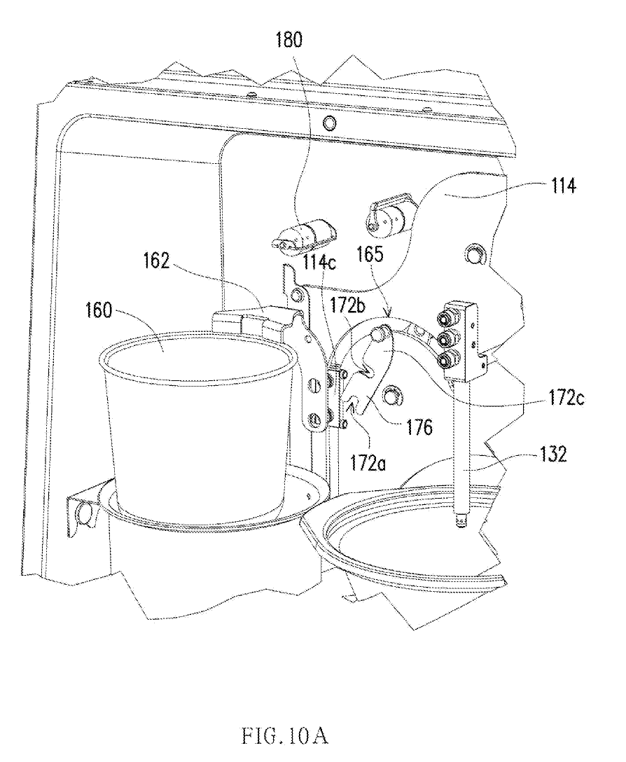

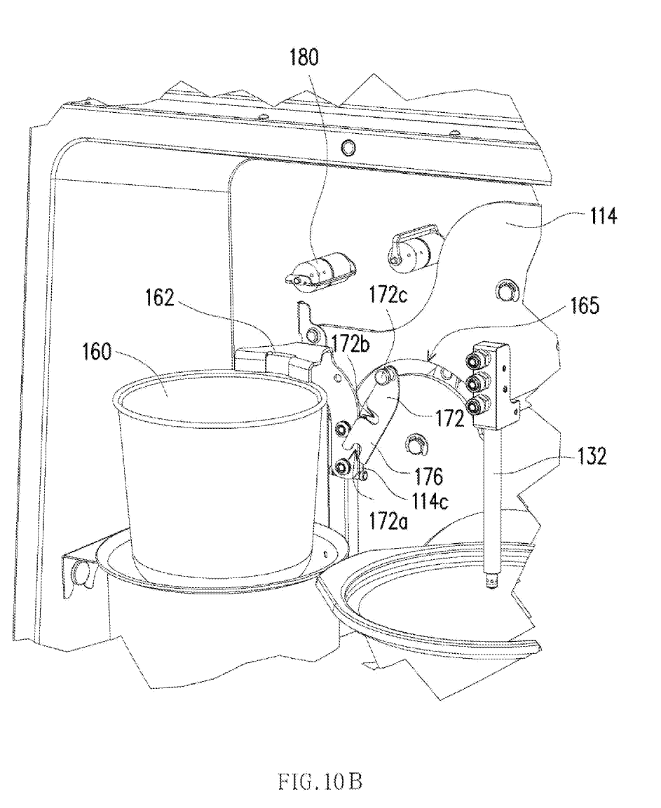

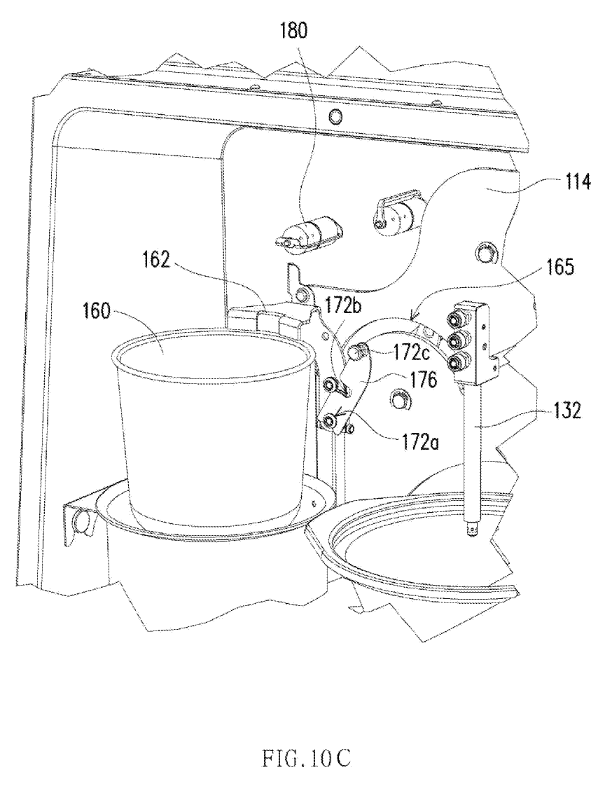

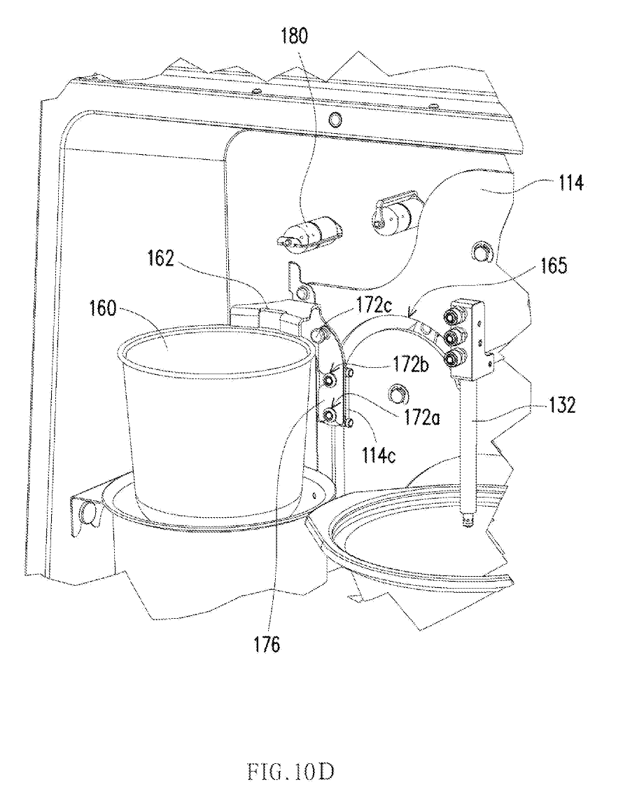

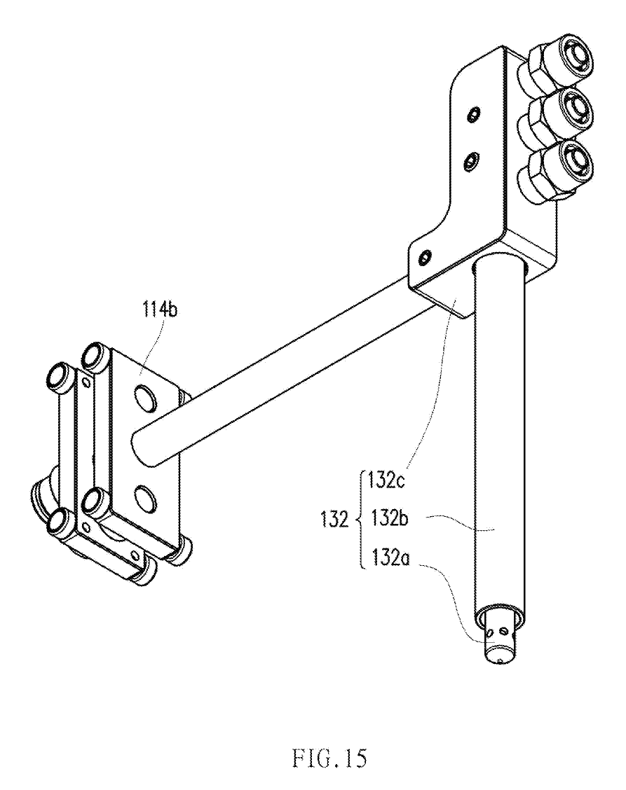

As shown in FIGS. 10A to 10D, the food container 160 is connected to the second slide 114c by connecting the handle 162 of the food container 160 to the second slide 114c, and as shown in FIG. 15C, the fixed recess 172a of the third quick-release 176 is engaged with one of the protrusions, and the pivots the pivot portion 172c about the protrusion that is engaged with the fixed recess 172a, such that the food container 160 is secured to the second slide 114c.

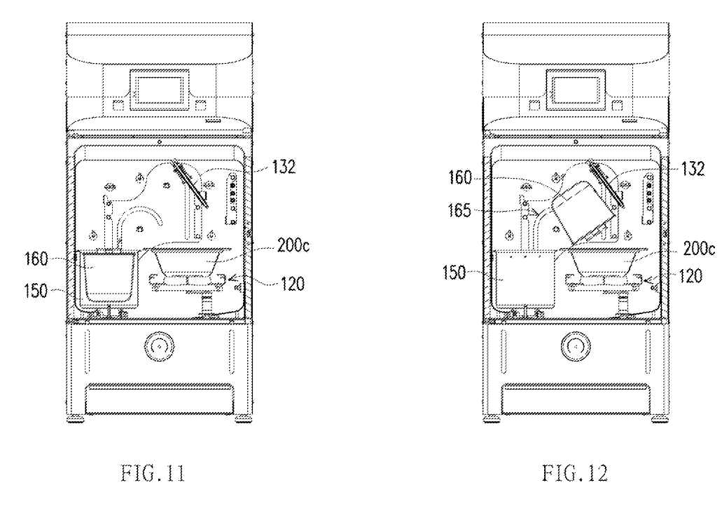

As shown in FIGS. 1, 7 and 11, when heating food, the injection hole 116a is opened electrically, water is injected into the liquid tank 150 via the injection hole 116a. The second heater 134 is inserted into the liquid tank 150 and heats the water in the liquid tank 150. When the temperature detection bar 118 detects that the water temperature reaches the pre-set value, the second slide 114c brings the food container 160 downward and enters into the water in the liquid tank 150 to heat the noodles in the food container 160. After the noodles are treated completely, the food container 160 is moved to pour the noodles into the bowl 200c on the container holder 120. The heating time can be set by programs or by manual way.

As shown in FIGS. 1, 11 and 12, the container rail 165 includes a curved portion such that the food container 160 is moved just like the movement of a chef does.

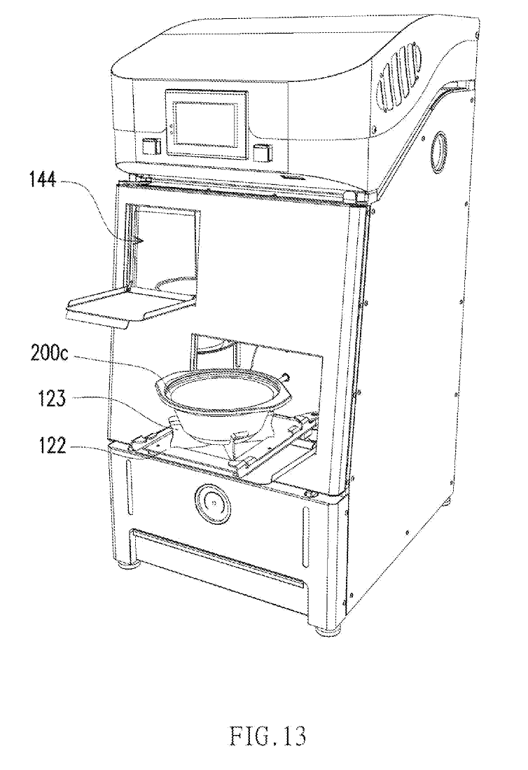

As shown in FIG. 13, the door 140 has a feeding hole 144 through which food is fed into the room 110a. The feeding hole 144 also has a door-like member so that food is fed into the food container 160.

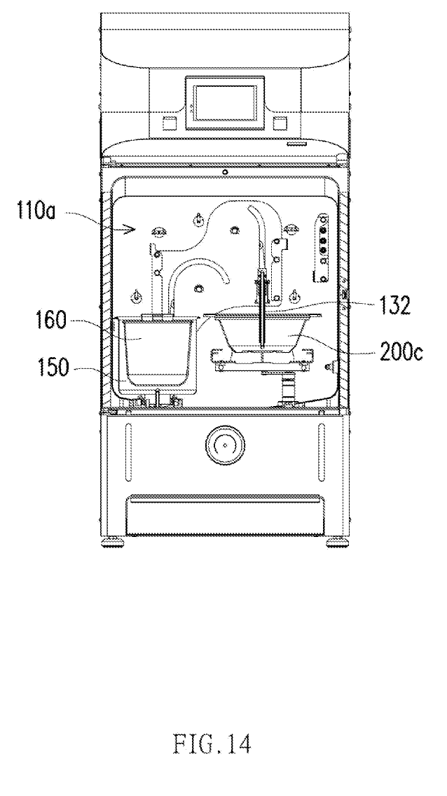

As shown in FIGS. 14 and 15, in order to cook noodles, the first heater 132 is able to provide soup into the bowl 200c.

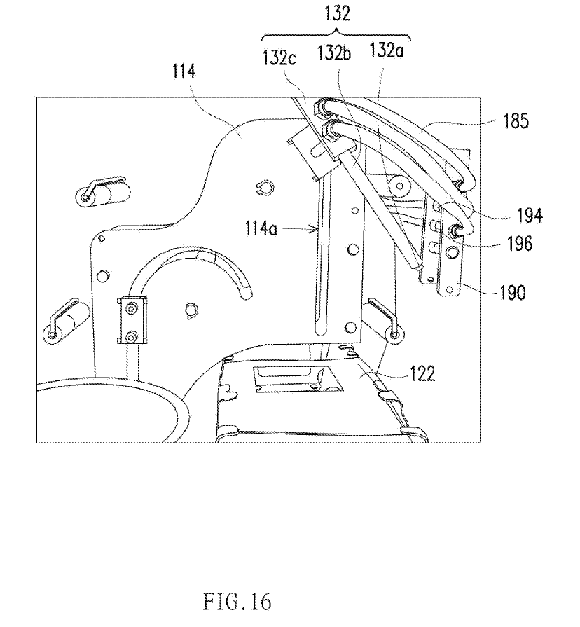

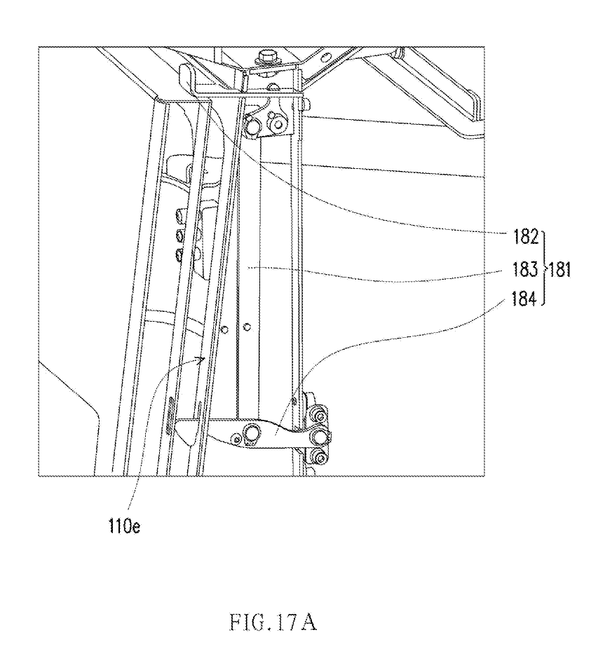

As shown in FIGS. 1, 15 and 16, the first heater 132 includes a first tube 132a, a second tube 132b and a third tube 132c. The second tube 132b is mounted to outside of the first tube 132a. The third tube 132c is mounted to the second tube 132b. The cooking machine 100 further comprises multiple pipes 185. Multiple supply sources 192, 194, 196 are respectively connected to the first, second and third tubes 132a, 132b, 132c via the multiple pipes 185. The supply source 192 supplies steam, the supply source 194 supplies water or soup, the supply source 196 supplies water. The cooking machine 100 includes a board 190 and a fourth quick-release 178. The multiple pipes 185 are connected to the board 190 which is fixed to the sidewalls 110d, 110e of the room 110a of the body 110 via the fourth quick-release 178. The fourth quick-release 178 includes a fixed recess 172a, an engaging recess 172b and a pivot portion 172c. The fixed recess 172a and the pivot portion 172c are located on two ends of the fourth quick-release 178. The engaging recess 172b is located between the fixed recess 172a and the pivot portion 172c.

After the soup is supplied, the power source 124a is activated again to move the tray 122 out from the room 110a as shown in FIG. 13 so that the uses can easily pick the food.

When cleaning the room 110a, the second tube 132b and the third tube 132c of the first heater 132 can be sued to supply water.

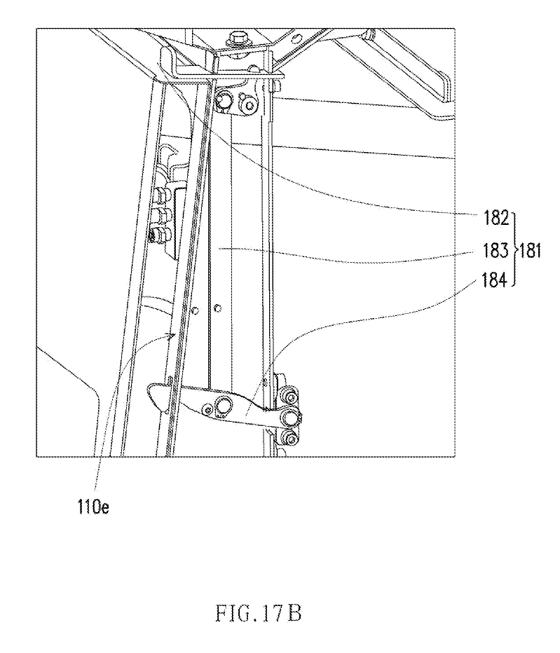

As shown in FIGS. 1, 17A and 17B, a door lock unit 181 is located at the other side of the body 110 and includes a switch 182, a link 183 and a hook 184. The switch 182 has one end exposed from the room 110a. The hook 184 protrudes beyond the sidewall 110e so as to hook the door 140. The link 183 is connected between the switch 182 and the hook 184. When the switch 182 is operated, the hook 184 is driven by the link 183 to be disengaged from the door 140. This is convenient for the users to open the door 140.

The cooking machine 100 has the advantages which are that the cooking machine 100 provides another choice that is different from the conventional cooking machine such as microwave oven, the traditional oven or boiling device. The cooking machine 100 can also be used in commercial stores such as convenience stores.

The food can be easily cooked by easy settings made by the users, and at least three different heating ways are provided to the users.

The container rail has the curved portion which moves the food container along a curved track such that the noodles in the food container can be poured into a bowl just like a chef does.

The parts of the rooms are assembled by quick-releases so that the parts are easily dis-assembled and maintained or replaced without using a screwdriver.

The power source is located outside of the room so that the sidewalls only carries related parts, the sealing feature of the room is better and the heat or liquid does not leak from the room. The power source is avoided from being accessed by the liquid and high temperature, and has a longer life of use.

While we have shown and described the embodiment in accordance with the present invention, it should be clear to those skilled in the art that further embodiments may be made without departing from the scope of the present invention.

1. A cooking machine comprising:
a body having a room defined therein;
a container holder movably located in the room and capable of removing out from the room, and
a heating unit having a first heater which is located in the room and movable to be inserted into a container on the container holder along a vertical direction so as to cook food in the container.

2. The cooking machine as claimed in claim 1, wherein the container holder has a support rail, a tray and a first driving unit, the support rail is located on an inner bottom of the room, the tray is movably put on the support rail, the first driving unit is connected to the tray which is driven by the first driving unit to move along the support rail to move the tray out from the room or to retreat the tray into the room.

3. The cooking machine as claimed in claim 2, wherein the container holder includes a first quick-release which is located in the room so as to position the support rail on the inner bottom of the room.

4. The cooking machine as claimed in claim 3, wherein the first quick-release has a fixed recess, an engaging recess and a pivot portion, the fixed recess and the pivot portion are located on two ends of the first quick-release, the engaging recess is located between the fixed recess and the pivot portion.

5. The cooking machine as claimed in claim 2, wherein the first driving unit comprises a power source, a pivot connected to the power source, and a first arm located in the room, a first end of the first arm is connected to the pivot and a second end of the first arm has a rod, the tray has a guide rail on an underside thereof, the rod is inserted into the guide rail.

6. The cooking machine as claimed in claim 2, wherein the tray has a positioning boss on each of four corners thereof.

7. The cooking machine as claimed in claim 6, wherein the container is a steamer which is put on the tray and positioned by the positioning bosses.

8. The cooking machine as claimed in claim 7, wherein the steamer comprises a top part, a bottom part and a rack, the rack is located between the top and bottom parts, the top part and the rack each have an aperture, the two respective apertures share a common axis, the first heater is inserted into the two respective apertures and reaches beneath of the rack.

9. The cooking machine as claimed in claim 2, wherein the tray has a positioning device at a center thereof.

10. The cooking machine as claimed in claim 9, wherein the tray has a pair of frames which are arranged to be an X-shaped combination and fixed to the positioning device.

11. The cooking machine as claimed in claim 10, wherein the container is a bowl or a plate, the container is put on the frames.

12. The cooking machine as claimed in claim 11, wherein the container includes a bowl cover which is mounted to the bowl, the bowl cover has an aperture, the first heater is inserted into the aperture and reaches an interior of the bowl.

13. The cooking machine as claimed in claim 1 further comprising a quick-release board and a second quick-release, the quick-release board is connected to a sidewall of the room by the second quick-release.

14. The cooking machine as claimed in claim 13, wherein the second quick-release has a fixed recess, an engaging recess and a pivot portion, the fixed recess and the pivot portion are located on two ends of the second quick-release, the engaging recess is located between the fixed recess and the pivot portion.

15. The cooking machine as claimed in claim 13, wherein the quick-release board includes a board and a first slide, the board includes a slot in which the first slide is located, the first heater is fixed to the first slide so as to be moved with the first slide along the slot.

16. The cooking machine as claimed in claim 13 further comprising a food container which is connected to the quick-release board, the quick-release board includes a board and a second slide, the board has a container rail, the second slide is movable along the container rail.

17. The cooking machine as claimed in claim 16, wherein the container rail has at least one curved portion.

18. The cooking machine as claimed in claim 16 further comprising a third quick-release, the food container is fixed to the second slide by the third quick-release.

19. The cooking machine as claimed in claim 18, wherein the third quick-release has a fixed recess, an engaging recess and a pivot portion, the fixed recess and the pivot portion are located on two ends of the third quick-release, the engaging recess is located between the fixed recess and the pivot portion.

20. The cooking machine as claimed in claim 16, wherein the first heater moves along the vertical direction and is pivoted relative to the vertical direction so as not to interfere the food container moving toward the container holder on the container rail.
